(19) United States
(12) Patent Application Publication
(10) Pub. No.: US 2006/0186681 A1
(43) Pub. Date: Aug. 24, 2006

(54) Universal grille accessory

(75) Inventor: James P. Elwell, Johnston, IA (US)

Correspondence Address: MCKEE, VOORHEES & SEASE, P.L.C., 801 GRAND AVENUE, SUITE 3200, DES MOINES, IA, 50309-2721, US

(73) Assignee: Putco, Inc., Story City, IA (US)

(21) Appl. No.: 11/064,400

(22) Filed: Feb. 23, 2005

(51) Int. Cl. B60R 13/00

(52) U.S. Cl. 296/1.08

(57) ABSTRACT

The current invention is a universal grille accessory adapted for replacing differently configured original vehicle grille logos and accommodating different vehicle grilles which have differently positioned logo mounting holes, depending on the make and model of a vehicle. The accessory comprises a body with opposite first and second sides, a design member or logo on the first side, a plurality of mounting apertures on the second side configured for mounting the accessory to a grille. The plurality of mounting apertures include a first set of mounting apertures for mounting to a first make and model of vehicle grille and a second set of mounting apertures for mounting to a second make and model of vehicle grille.

### BACKGROUND OF THE INVENTION

This invention relates to after market accessories for vehicles. Specifically, this invention relates to a universal grille accessory or trim attachment for attaching an after market decorative design or logo to various makes and models of vehicle grills.

It has become popular in recent years to decorate one's vehicle with after market trim attachments. Many of these after market trim attachments can be attached using double sided tape. However, using double sided tape does not allow the trim attachment to be removed easily.

FIG. 1 shows an after market grille attachment. An original equipment manufacturer's logo 12 is removed from a vehicle grille 10 and then a decorative after market grille accessory can be attached to the grille 10 in the place where the original equipment manufacturer (OEM) logo 12 was located.

Generally, the OEM logo 12 is attached to a grille 10 with posts or lugs which mount through the OEM logo mounting holes 14. Therefore, many times when an OEM logo 12 is removed in order to replace with an after market trim attachment, the OEM logo mounting holes 14 are used to attach the new after market trim attachment to the grille 10.

The problem with using the OEM logo mounting holes 14 to mount an after market trim attachment piece to a manufacturer's grille 10 is that the various makes and models of vehicles have the OEM logo mounting holes 14 located in different positions or locations relative to the grille 10. Thus, the trim accessory must be manufactured in various forms to match the non-universal mounting holes of the vehicles. Therefore, it is desirable to have a universal after market trim attachment piece which can attach to any vehicle grille 10 in the place of an OEM logo 12 on multiple makes and models of vehicles with regards to the varying locations of OEM logo mounting holes 14, without having to mold separate after market attachments for each specific make and model of vehicle in which the attachment can be used on.

The primary objective of the present invention is to provide a universal grille accessory or attachment for attaching to grilles of multiple makes and models of vehicles.

Another objective of the present invention is a method of attaching an after market decorative design or logo accessory to the grille of any vehicle make or model.

Another objective of the present invention is a method allowing one to remove the after market decorative design or logo accessory and reattach the original OEM logo.

A further objective of the present invention is the provision of a grille accessory which is economical to manufacture, durable in use and efficient in operation.

These and other objects of the invention will be apparent from the specification and claims that follow.

### SUMMARY OF THE INVENTION

The foregoing objects may be achieved by a universal grille accessory adapted for replacing differently configured original vehicle grille logos which have mounting holes positioned differently for different original logos, depending on make and model of vehicle. The accessory comprises a body with opposite first and second sides, a design member or logo on the first side, a plurality of mounting apertures on the second side configured to adapt the grille insert for mounting. The plurality of mounting apertures include at least a first set of mounting apertures for mounting to a first make and model of vehicle grille, and a second set of mounting apertures for mounting to a second make and model of vehicle grille.

Another feature of the present invention involves a grille accessory having a body with mounting apertures configured to receive mounting studs.

Another feature of the present invention involves a grille accessory having a body with mounting studs extending from one or more mounting apertures and aligning with one or more original logo mounting holes in the vehicle grille.

A further feature of the present invention involves a grille accessory having a body with mounting studs secured to a vehicle grille through one or more of the original logo mounting holes in the vehicle grille.

Yet another feature of the present invention involves a grille accessory having a body configured so that the accessory can be removed from a vehicle grille and the original vehicle logo can be reattached to the grille.

The foregoing objects may also be achieved by a decorative vehicle grille accessory for attaching to an automotive grille in place of an original vehicle's grille logo comprising a body with a first side and an opposite second side, the first side configured with a decorative design member or logo, the second side configured with a plurality of mounting holes for connecting the accessory body to a vehicle grille, and the number and placement of mounting holes are defined to accommodate differently configured vehicle grilles, such that each of the differently configured vehicle grilles uses a set of holes from a plurality of mounting holes.

The foregoing objects may additionally be achieved by a method of applying a universal grille accessory to a vehicle grille comprising the steps of removing an original vehicle logo from the grille of a vehicle, providing a decorative grille accessory which is configured with a plurality of universal mounting holes on a backside of the accessory, wherein the holes are located so as to align with one or more original mounting holes in the vehicle's grille of at least two different makes and models of vehicles, attaching mounting studs in one or more of the mounting holes of the accessory so that the studs project from the accessory and align with the one or more original mounting holes of the vehicle's grille, inserting the mounting studs through the mounting holes of grille, and securing the accessory to the grille via the mounting studs.

A further feature of the present invention involves a decorative grille accessory which is removable from a vehicle grille in order to reattach the original vehicle logo to the vehicle grille.

The decorative design members or elements referred to for this invention can refer to decorative designs that are either generic, which do not refer to specific entities, or are logos which specifically identify certain entities such as, but not limited to, colleges or universities, sports teams, name brands, and the like.

The apertures referred to for this invention can be holes, openings, or other similar indentions. Alternatively, the apertures can be replaced with prongs, pegs, bars and other like extensions.

### BRIEF DESCRIPTION OF THE DRAWINGS

FIG. 1 is an exploded perspective view of an OEM vehicle logo and a vehicle grille.

FIG. 2 is an exploded perspective view of a grille accessory invention and a vehicle grille.

FIG. 3 is a rear elevation view of the backside of the accessory invention.

FIG. 4 is a top plan view of one embodiment of the mounting for the accessory invention.

FIG. 5 is an exploded side elevation view showing another embodiment for the mounting of the accessory invention.

### DETAILED DESCRIPTION OF THE PREFERRED EMBODIMENT

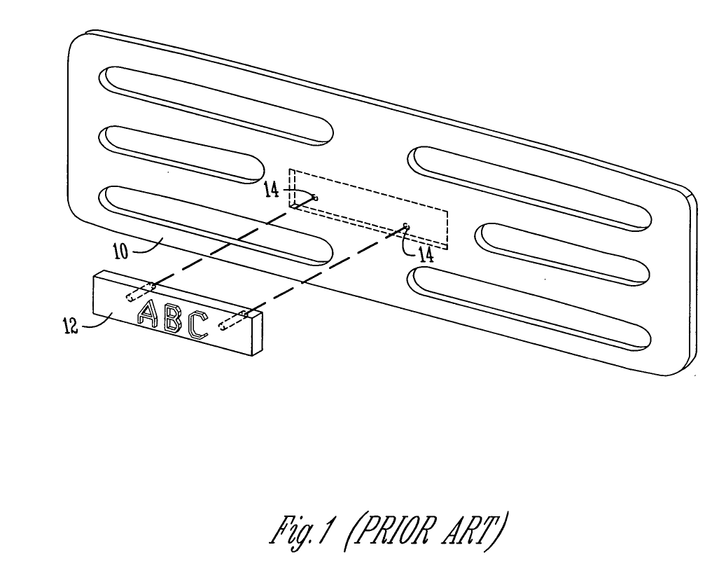

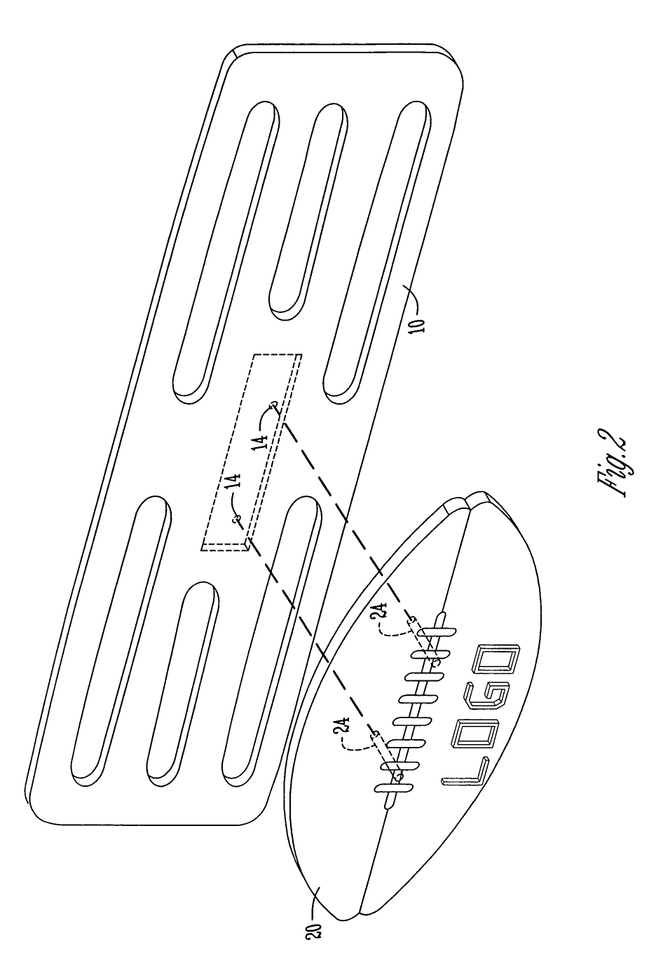

This invention provides a universal grille accessory having a decorative design or logo which can be mounted to many different vehicle grilles. FIG. 1 shows a prior art assembly of a vehicle grille 10 with an original equipment manufacturer (OEM) logo 12. When the logo 12 is removed from the grille 10, the OEM logo mounting holes 14 on the vehicle grille 10 are exposed. The different makes and models of vehicles have OEM logo mounting holes 14 located in different locations on the vehicle grille 10. Therefore, the current invention provides a decorative design or logo accessory 20, as seen in FIG. 2, which can be adapted for many different OEM logo mounting holes 14 in different positions for different makes and models of vehicles.

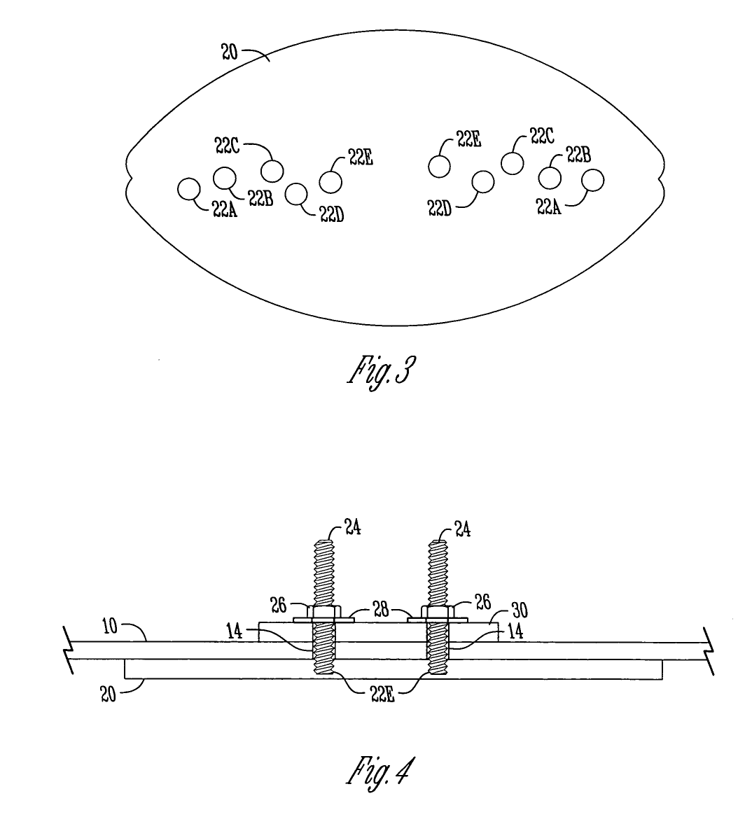

The decorative design or logo accessory 20 shown in FIGS. 2 and 3 can be made in any shape or design, and may include any name, words, colors, symbols, and the like.

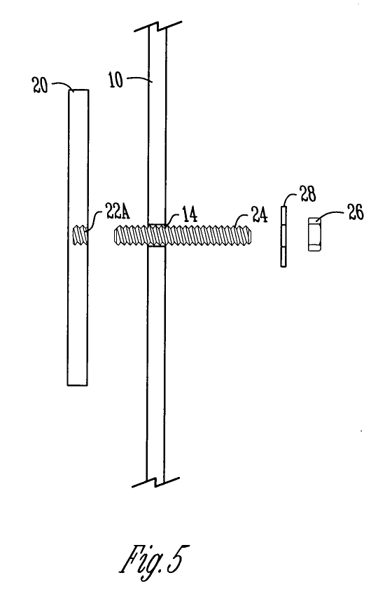

Referring to FIGS. 2 and 3, the decorative accessory 20 can be attached to the vehicle grille 10 with mounting studs 24 passing through the OEM logo mounting holes 14. It is then preferred that as the mounting studs 24 pass through the grille 10, they can secure the accessory 20 to the grille 10 by any convenient means, such as nuts 26, as shown in FIGS. 4 and 5.

Referring to FIG. 3, universal mounting apertures 22A-E are arranged so as to create pairs or sets of mounting apertures. Each pair of apertures 22A-E can be utilized for mounting a decorative design or logo 20 to a grille 10. For example, apertures 22A are used for mounting the accessory 20 to the grille 10 of one particular make and model of vehicle. Another make and model of vehicle could use apertures 22B; and still another make and model of vehicle could use aperture set 22C for mounting the accessory 20 to the grille 10 using the OEM logo mounting holes 14. Some vehicles may use only one mounting aperture 22A-E. Other vehicles may use more than one pair or set of apertures 22A-E.

It is preferred, but not necessary, that the mounting studs 24 are threaded and able to screw into one or more of the universal mounting apertures or holes 22A-E on the back of the accessory 20. In addition, it is preferred that a washer 28 or a bracket 30 be used on the mounting studs 24, which are each secured by a nut 26. However, the use of threaded mounting studs 24 which thread into the universal mounting apertures 22 on the accessory 20 are only exemplary, and any securing method capable of locating to universal mounting apertures 22A-E are acceptable, such as molded studs which can be broken off if not used. Additionally, the universal mounting apertures 22 can be replaced with any type of universal mounting locator capable of allowing the accessory 20 to affix to multiple makes and models of vehicle grille 10.

The universal mounting apertures 22 or universal mounting locators allow for one accessory 20 to be manufactured which will mount to multiple makes and models of vehicle grille 10. For instance, as shown in FIG. 2, the universal mounting apertures 22E are used for locating the mounting studs 24 in the accessory 20 so that when the mounting studs 24 pass through the OEM logo mounting holes 14 on a particular make and model of vehicle for this grille 10, the accessory 20 is aligned on the grille 10. A different make and model of vehicle may use apertures 22A, B, C or D for aligning the accessory 20 to that make and model of vehicle grille. Previously, each vehicle make and model would require a different accessory due to the different patterns of mounting holes 14.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A universal grille accessory adapted for replacing original vehicle grille logos on different vehicle grilles, comprising:
a body with opposite first and second sides;
a design element on the first side;
one or more mounting apertures on the second side of the body for mounting the body to a first make and model of vehicle grille; and
one or more different mounting apertures on the second side of the body for mounting the body to a second make and model of vehicle grille.

2. The accessory of claim 1 further comprising mounting studs selectively receivable in the mounting apertures.

3. The accessory of claim 2 wherein the mounting studs extend from the mounting apertures and align with one or more original logo mounting holes in the vehicle grille.

4. The accessory of claim 3 wherein the mounting studs are secured to the vehicle grille through one or more of the original logo mounting holes in the vehicle grille.

5. The accessory of claim 4 wherein the accessory is removable from the vehicle grille and the original vehicle logo can be reattached to the grille.

6. A vehicle grille attachment for attaching to an automotive grille in place of an original vehicle's grille logo, comprising:
a body with a first side and an opposite second side;
the first side configured with a decorative design member or a logo;
the second side configured with a plurality of mounting holes for connecting the body to a vehicle grille; and
the number and placement of mounting holes being defined to accommodate differently configured vehicle grilles, such that each of the differently configured vehicle grilles uses a set of the plurality of mounting holes.

7. The grille attachment of claim 6 further comprising mounting stud for receipt in the set of mounting holes.

8. The grille attachment of claim 7 wherein the mounting studs align with original logo mounting holes in the vehicle grille.

9. The grille attachment of claim 8 further comprising nuts received on the mounting studs to secure the body to the vehicle grille.

10. The grille attachment of claim 9 wherein the grille attachment is removable from the vehicle grille such that the original vehicle logo can be reattached to the grille.

11. A method of mounting a universal grille accessory to a vehicle grille comprising the steps of:
removing an original vehicle logo from a grille of a vehicle;
selectively connecting at least one mounting stud to a first mounting aperture selected from a plurality of mounting apertures on a back side of the accessory, wherein the number and placement of mounting apertures accommodate differently configured vehicle grills such that the stud aligns with an original mounting hole in the grille of a first vehicle;
extending the stud through the aligned hole on the grille; and
securing the accessory to the grille.

12. The method of claim 11 further comprising selectively connecting the mounting studs to a second pair of mounting apertures on the back side of the accessory, such that the studs align with original mounting holes in the grille of a second vehicle.

13. The method of claim 11 further comprising removing the accessory from the vehicle grille and re-attaching the original vehicle logo to the vehicle grille.
